(19) United States
(12) Patent Application Publication
(10) Pub. No.: US 2017/0365876 A1
(43) Pub. Date: Dec. 21, 2017

(54) METHODS AND COMPOSITIONS FOR LITHIUM ION BATTERIES

(71) Applicant: BATTELLE MEMORIAL INSTITUTE, Richland, WA (US)

(72) Inventors: Ji-Guang Zhang, Richland, WA (US); Xiaochuan Lu, Richland, WA (US); Wu Xu, Richland, WA (US); Jiangfeng Qian, Richland, WA (US); Jie Xiao, Richland, WA (US); Bo Liu, Richland, WA (US); Yuyan Shao, Richland, WA (US); Dongping Lu, Richland, WA (US); Daniel Deng, Richland, WA (US); Tianbiao Liu, Logan, UT (US); Qiuyan Li, Richland, WA (US)

(73) Assignee: BATTELLE MEMORIAL INSTITUTE, Richland, WA (US)

(21) Appl. No.: 15/691,424

(22) Filed: Aug. 30, 2017

Related U.S. Application Data
(62) Division of application No. 14/523,554, filed on Oct. 24, 2014.

(51) Int. Cl. H01M 10/0562; H01M 10/0585; H01M 4/38; H01M 4/04; H01M 4/485; H01M 10/052; H01M 10/056

(52) U.S. Cl. CPC H01M 10/0562; H01M 10/052; H01M 10/0585; H01M 10/056; H01M 4/043; H01M 4/485; H01M 4/386; H01M 4/382; H01M 2300/008

(57) ABSTRACT

A solid-state lithium ion battery is disclosed. The battery includes an anode containing an anode active material. The battery also includes a cathode containing a cathode active material. The battery further includes a solid-state electrolyte material. The electrolyte material contains a salt or salt mixture with a melting point below approximately 300 degrees Celsius. The battery has an operating temperature of less than about 80 degrees Celsius.

### STATEMENT REGARDING FEDERALLY SPONSORED RESEARCH OR DEVELOPMENT

The invention was made with Government support under Contract DE-AC05-76RL01830, awarded by the U.S. Department of Energy. The Government has certain rights in the invention.

### TECHNICAL FIELD

This invention relates to lithium (Li)-ion batteries. More specifically, this invention involves methods of manufacturing and electrolyte compositions for Li-ion batteries.

### BACKGROUND OF THE INVENTION

Li-ion batteries are one of the key energy storage technologies for transportation applications such as electric vehicles (EVs) and plug-in hybrid electric vehicles (PHEVs), which require high energy density, long cycle and calendar life, low cost and high safety. State-of-the-art Li-ion batteries typically use organic carbonate solvents in electrolytes, which may lead to serious safety issues such as fire and explosion due to their high flammability, especially in the case of accidental damages such as car collisions.

Replacing the flammable organic liquid electrolytes with non-volatile, nonflammable, dense solid-state electrolytes can resolve the safety problems of Li-ion batteries. Materials for solid electrolytes can be crystalline, glassy, polymeric and composite. Unfortunately, most of these materials either have inferior electrochemical performance (e.g., low ionic conductivity, narrow electrochemical window, etc.) or poor chemical or physical properties (e.g., poor compatibility with electrode materials, thermal instability and low mechanical strength, etc.). Another major challenge of all-solid-state Li-ion batteries is the high interfacial or contact resistance between the solid electrolyte and electrode particles. Without high temperature treatment, such contact is poor and leads to a high interfacial polarization. High-temperature sintering (>400° C.) leads to better contact among the particles, however, it may also lead to the performance deterioration or even decomposition of active electrode materials.

### SUMMARY OF THE INVENTION

The present invention is directed to solid-state Li-ion batteries, electrolyte compositions, and methods of manufacturing a battery. In one embodiment, a solid-state Li-ion battery is disclosed. The battery includes an anode containing an anode active material. The battery also includes a cathode containing a cathode active material. The battery further includes a solid-state electrolyte material. The electrolyte material contains a salt or salt mixture with a melting point below approximately 300 degrees Celsius, and the battery has an operating temperature of less than about 80 degrees Celsius.

The anode active material may be, but is not limited to, Li, graphite, Si, SiOₓ (0<x≦2), Sn, SnO₂, Ge, Co₂O₃, Fe₂O₃, TiO₂, Li₄Ti₅O₁₂, or combinations thereof.

In one embodiment, the cathode active material is a lithium intercalation compound or a lithium containing compound. The cathode active material may be, but is not limited to, Li₄₋ₓMₓTi₅O₁₂ (M=Mg, Al, Ba, Sr, or Ta; 0≦x≦1), MnO₂, Li₃V₂O₅, LiV₃O₈, LiM^{C1}ₓM^{C2}₁₋ₓO₂ ((M^{C1} or M^{C2}=Fe, Mn, Ni, Co, Cr, Ti, Mg, Al; 0≦x≦1), LiM^{C1}ₓM^{C2}_{y}M^{C3}_{1-x-y}O₂((M^{C1}, M^{C2}, or M^{C3}=Fe, Mn, Ni, Co, Cr, Ti, Mg, or Al; 0≦x≦1; 0≦y≦1), LiMn_{2-y}X_{y}O₄ (X=Cr, Al, or Fe, 0≦y≦1), LiNi_{0.5-y}X_{y}Mn_{1.5}O₄ (X=Fe, Cr, Zn, Al, Mg, Ga, V, or Cu; 0≦y<0.5), xLi₂MnO₃.(1-x)LiM^{C1}_{y}M^{C2}_{z}M^{C3}_{1-y-z}O₂ (M^{C1}, M^{C2}, or M^{C3}=Mn, Ni, Co, Cr, Fe, or mixture of; x=0.3-0.5; y≦0.5; z≦0.5), Li₂MSiO₄ (M=Mn, Fe, or Co), Li₂MSO₄ (M=Mn, Fe, or Co), LiMSO₄F (Fe, Mn, or Co), LiM^{C1}ₓM^{C2}₁₋ₓPO₄ (M^{C1} or M^{C2}=Fe, Mn, Ni, Co, Cr, or Ti; 0≦x≦1), Li₃V₂₋ₓMₓ(PO₄)₃ (M=Cr, Co, Fe, Mg, Y, Ti, Nb, or Ce; 0≦x≦1), LiVPO₄F, Li₂₋ₓ(Fe_{1-y}Mn_{y})P₂O₇ (0≦y≦1), or combinations thereof.

The electrolyte material may be, but is not limited to, LiN(SO₂F)₂ (i.e., LiFSI), LiN(SO₂CF₃)₂ (i.e., LiTFSI), CsN(SO₂CF₃)₂ (i.e., CsTFSI), LiFeCl₄, NaFeCl₄, CsI, LiI, CsNO₃, LiNO₃, KNO₃, NaNO₃, AlF₃, LiAlCl₄ and NaAlCl₄, or combinations thereof. One or more of these electrolytes can be combined with other solid-state Li-ion conductors such as LISICON, Li₇La₃Zr₂O₁₂, doped Li₇La₃Zr₂O₁₂, Li-beta-alumina, Li₃ₓLa_{2/3-x}TiO₃ (LLTO) (x=0.05 to 0.3), or combinations thereof.

In one embodiment, the electrolyte is a mixture of LiTFSI and LiFSI. In another embodiment, the electrolyte is a mixture of 10 to 30 mol % LiTFSI and 70 to 90 mol % LiFSI.

In one embodiment, the anode active material is Li₄Ti₅O₁₂, the cathode active material is LiFePO₄ or LiCoO₂, and the electrolyte is LiTFSI.

In one embodiment, the anode active material is Li₄Ti₅O₁₂, the cathode active material is LiFePO₄ or LiCoO₂, and the electrolyte is a mixture of LiTFSI and CsTFSI consisting of 10 to 30 mol % LiTFSI and 70 to 90 mol % CsTFSI.

In one embodiment, the anode active material is Li₄Ti₅O₁₂, the cathode active material is LiFePO₄ or LiCoO₂, and the electrolyte is a mixture of LiAlCl₄ and NaAlCl₄ consisting of 45 to 65 mol % LiAlCl₄ and 35 to 55 mol % NaAlCl₄.

In another embodiment of the present invention, a method of manufacturing a solid-state Li-ion battery is disclosed. The method includes preparing a molten-state electrolyte layer slurry and casting it on a non-metallic porous membrane. The method also includes preparing a cathode layer slurry containing the electrolyte, a cathode active material and a conductive carbon, and casting the cathode slurry on an aluminum substrate. The method also includes preparing an anode layer slurry containing the electrolyte, an anode active material and a conductive carbon, and casting the anode slurry on a copper substrate. The method also includes stacking together the cathode layer, the electrolyte layer and the anode layer. The method further includes laminating or hot pressing the stacked layers, wherein the battery is manufactured at temperatures below 300 degrees Celsius.

In one embodiment, the battery is manufactured at temperatures below 150 degrees Celsius.

The electrolyte for the electrolyte slurry contains a salt or salt mixture selected from at least one of the following: LiTFSI, LiFSI, CsTFSI, LiTFSI and LiFSI, LiTFSI and CsTFSI, LiAlCl₄ and NaAlCl₄, LiFeCl₄, NaFeCl₄, CsI, LiI, CsNO₃, LiNO₃, KNO₃, NaNO₃, AlF₃, and combinations thereof. The electrolyte can be combined with other solid-state Li-ion conductors such as LISICON, Li₇La₃Zr₂O₁₂, doped Li₇La₃Zr₂O₁₂, Li-beta-alumina, Li₃ₓLa_{2/3-x}TiO₃ (LLTO) (x=0.05 to 0.3), or combinations thereof.

In one embodiment, the electrolyte is a mixture of LiTFSI and LiFSI.

In one embodiment, the electrolyte mixture is 10 to 30 mol % LiTFSI and 70 to 90 mol % LiFSI.

In another embodiment of the present invention, a method of manufacturing a solid-state Li-ion battery is disclosed. The method includes dissolving a solid-state electrolyte into a first organic solvent with a boiling point less than 210 degrees Celsius to form an electrolyte slurry layer, wherein the electrolyte slurry is cast on a non-metallic porous membrane and the first organic solvent is evaporated. The method also includes dispersing or mixing cathode active material powder, and conductive carbon into a solution of the solid-state electrolyte dissolved in second organic solvent with a boiling point less than 210 degrees Celsius to form a cathode slurry layer, wherein the cathode slurry is cast on an aluminum substrate and the organic solvent is evaporated. The method further includes dispersing or mixing an anode active material powder, and conductive carbon into a solution of the solid-state electrolyte dissolved in third organic solvent with a boiling point less than 210 degrees Celsius to form a anode slurry layer, wherein the anode slurry is cast on a copper substrate and the organic solvent is evaporated. The method further includes stacking together the layers by laminating or pressing, wherein the battery manufacturing is carried out at temperatures below 300 degrees Celsius.

In one embodiment, the first, second, and third organic solvents are the same. The organic solvent may be, but is not limited to, dimethyl carbonate (DMC).

In another embodiment of the present invention, a method of manufacturing a solid-state Li-ion battery is disclosed. The method includes dissolving cathode powders containing a solid-state electrolyte, a cathode active material, and a conductive carbon into a first organic solvent with a boiling point less than 210 degrees Celsius to form a cathode slurry layer, wherein the cathode slurry is cast on an aluminum substrate and the first organic solvent is evaporated. The method also includes dissolving the solid-state electrolyte into a second organic solvent with a boiling point less than 210 degrees Celsius to form an electrolyte slurry layer, wherein the electrolyte slurry is cast on the surface of the cathode layer and the second organic solvent is evaporated. The method also includes dispersing or mixing an anode active material, and a conductive carbon into a third organic solvent with a boiling point less than 210 degrees Celsius to form an anode slurry layer, wherein the anode slurry is cast on the surface of the electrolyte layer on the cathode surface, and a copper substrate is placed on top of the anode slurry layer and the third organic solvent is evaporated. The method further includes laminating the layers, wherein the battery manufacturing is carried out at temperatures below 300 degrees Celsius. The organic solvents may be the same or different.

In another embodiment of the present invention, a method of manufacturing a solid-state Li-ion battery is disclosed. The method includes preparing a molten-state electrolyte layer slurry, a cathode layer slurry containing the electrolyte, a cathode active material and a conductive carbon, and an anode layer slurry containing the electrolyte, an anode active material and a conductive carbon. The method also includes stacking the layers together on a substrate, rolling the stacked layers, and carrying out the battery manufacturing at temperatures below 300 degrees Celsius. In one embodiment, the battery is manufactured at temperatures below 150 degrees Celsius.

In one embodiment, the electrolyte for the electrolyte slurry layer contains a salt or salt mixture selected from at least one of the following: LiTFSI, LiFSI, CsTFSI, LiTFSI and LiFSI, LiTFSI and CsTFSI, LiAlCl₄ and NaAlCl₄, LiFeCl₄, NaFeCl₄, CsI, LiI, CsNO₃, LiNO₃, KNO₃, NaNO₃, AlF₃, LiFTI, and combinations thereof. The electrolyte can be combined with other solid-state Li-ion conductors such as LISICON, Li₇La₃Zr₂O₁₂, doped Li₇La₃Zr₂O₁₂, Li-beta-alumina, Li₃ₓLa_{2/3-x}TiO₃ (LLTO) (x=0.05 to 0.3), or combinations thereof.

In one embodiment, the electrolyte is a mixture of LiTFSI and LiFSI.

In one embodiment, the electrolyte mixture is 10 to 30 mol % LiTFSI and 70 to 90 mol % LiFSI.

In another embodiment of the present invention, an electrolyte mixture for a solid-state Li-ion battery comprises LiTFSI and LiFSI.

In one embodiment, the electrolyte mixture is 10 to 30 mol % LiTFSI and 70 to 90 mol % LiFSI. In another embodiment, the electrolyte mixture is approximately 20 mol % LiTFSI and approximately 80 mol % LiFSI.

In another embodiment of the present invention, an electrolyte mixture for a solid state lithium battery comprises 0 to 100 mol % LiTFSI. In one embodiment, the electrolyte mixtures further includes, but is not limited to, at least one of the following: Li-beta-alumina and Li₇La₃Zr₂O₁₂.

### BRIEF DESCRIPTION OF THE DRAWINGS

FIG. 1 is a schematic diagram of a solid-state Li-ion battery, in accordance with one embodiment of the present invention.

FIG. 2 is the schematic for a real battery design corresponding to FIG. 1 and designed as a test apparatus to evaluate characteristics of the solid-state Li-ion battery of the present invention.

FIG. 3 is a table of ionic conductivities (mS/cm) of several lithium salt mixtures for electrolytes at different temperatures, in accordance with one embodiment of the present invention. Pt metal is used as both cathode and anode in a symmetric configuration.

FIG. 4 shows a cyclic voltammogram curve of the salt mixture of 20 mol % LiTFSI and 80 mol % LiFSI in the voltage range from 0.1 to 6 V. Pt metal is used as both cathode and anode in a symmetric configuration.

FIG. 5 shows a phase diagram for the LiFSI and LiTFSI binary system.

FIG. 6 shows stability of an electrolyte mixture which is approximately 20 mol % LiTFSI and approximately 80 mol % LiFSI in a solid-state Li-ion battery. Pt is used as the electrode in a symmetric cell.

FIG. 7 shows charge/discharge characteristics of the solid-state Li-ion battery with a low-melting point lithium salt mixture electrolyte using LiFePO₄ as cathode and Li metal as anode.

FIG. 8 shows the capacity and efficiency of the solid-state Li-ion battery with a low-melting point lithium salt mixture electrolyte at different cycle numbers. LiFePO₄ is used as cathode and Li metal is used as anode.

FIG. 9 shows the voltage profile of a solid-state Li—S battery with a low-melting point lithium salt mixture electrolyte during the first charge/discharge cycle.

FIG. 10 shows a voltage curve of the first charge/discharge cycle of a solid-state Li-ion battery with LITFSI as the electrolyte at a current density of 0.01 mA/cm².

FIG. 11A shows the morphology of pristine LITFSI pellets.

FIG. 11B shows the morphology of melted LITFSI pellets at approximately 280 degrees Celsius.

FIG. 12 shows the effects of 10 cycles of a solid-state Li-ion battery with LITFSI mixed with AL₂O₃(1:1 wt.) as the electrolyte at a current density of 0.01 mA/cm².

FIG. 13 shows a representative chronopotentiometry test of a LiTFSI solid-state electrolyte using a half cell configuration in which the solid-state electrolyte was sandwiched between two stainless steel current collectors loaded with Li metal discs. The cycling time for 10 cycles was 200 seconds for each cycle, and the cycling profile shows ca. 0.06 V overpotential.

### DETAILED DESCRIPTION OF THE PREFERRED EMBODIMENTS

The present invention is directed to Li-ion batteries, methods of manufacturing batteries, and electrolyte compositions that enable increased power and energy density and cycle life, reduced costs from the use of low-cost precursor which are compatible with high-volume manufacturing, and improved safety because of the absence of flammable electrolytes.

The present invention also involves the use of specific low melting point inorganic salts as electrolytes. The use of these materials allows the batteries to be fabricated at relatively low temperatures between approximately 100 to approximately 300 degrees Celsius.

In one embodiment, the electrolyte is in a molten or softened state during the fabrication process. This can ensure intimate contacts among the particles of the electrolyte and electrode. In addition, because of the relatively low fabrication temperatures, the properties and structures of electrode active materials will not deteriorate during the fabrications process.

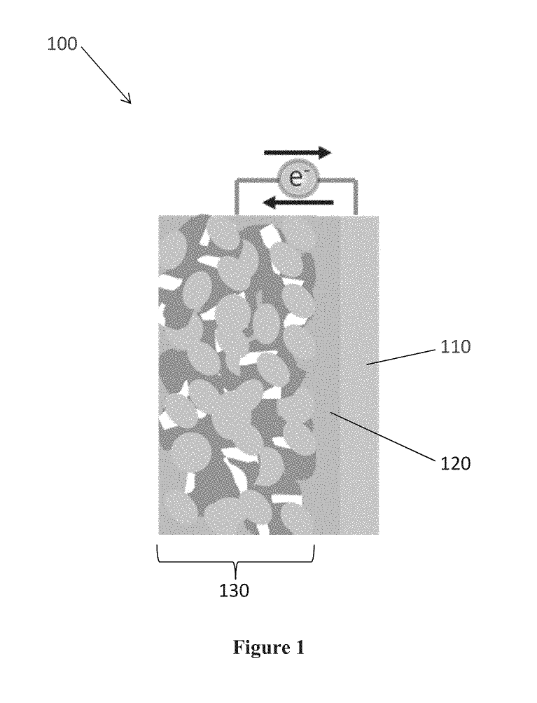

FIG. 1 is a schematic diagram of a solid-state Li-ion battery 100, in accordance with one embodiment of the present invention. The battery 100 includes an anode 110, a solid-state electrolyte 120, and a cathode 130. In the battery 100, the electrolyte 120 or components in the electrolyte 120 is a low melting-point—e.g. approximately 100-300° C. in one embodiment and below 150° C. in another embodiment.

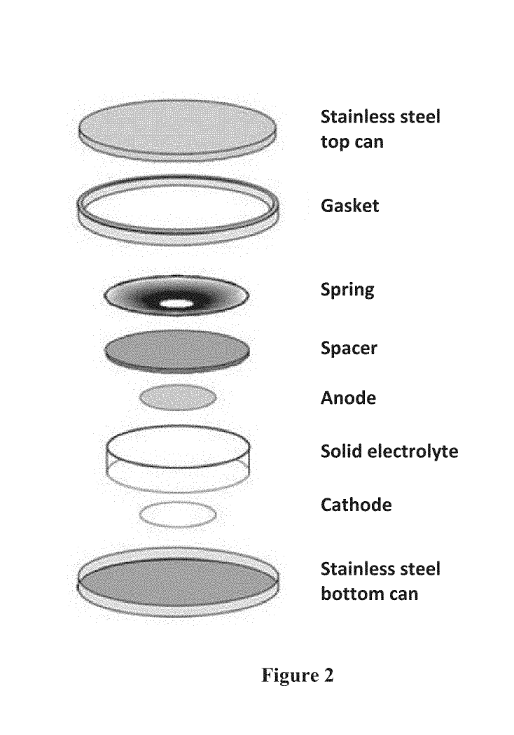

FIG. 2 is the schematic for a real battery design corresponding to FIG. 1 and designed as a test apparatus to evaluate characteristics of the solid-state Li-ion battery of the present invention. The test battery comprises a stainless steel top can, a gasket, a stainless steel spring, a stainless steel spacer, an anode, a solid electrolyte, a cathode, and a stainless steel bottom can. Other electrochemical cell designs according to various embodiments may be used as the test apparatus.

The electrolyte 120 can be, but is not limited to, salt or salt mixtures such as LiFSI, LiTFSI, CsTFSI, LiFeCl₄, NaFeCl₄, CsI, LiI, CsNO₃, LiNO₃, KNO₃, NaNO₃, AlF₃, mixture of LiTFSI and CsTFSI, mixture of LiAlCl₄ and NaAlCl₄, and mixture of LiFSI and LiTFSI. The electrolyte 120 can also be a combination between the above-mentioned salt or salt mixtures and other solid-state Li-ion conductors such as, but not limited to LISICON, Li₇La₃Zr₂O₁₂, doped Li₇La₃Zr₂O₁₂, Li-beta-alumina, Li₃ₓLa_{2/3-x}TiO₃ (LLTO) (x=0.05 to 0.3).

In one embodiment, the electrolyte is a mixture of 10 to 30 mol % LiTFSI and 70 to 90 mol % LiFSI. In another embodiment, the electrolyte is LiTFSI. In one specific embodiment, the electrolyte is a mixture of approximately 20 mol % LiTFSI and approximately 80 mol % LiFSI. In another embodiment, the electrolyte is a mixture of LiTFSI and CsTFSI consisting of 10 to 30 mol % LiTFSI and 70 to 90 mol % CsTFSI. In yet another embodiment, the electrolyte is a mixture of LiAlCl₄ and NaAlCl₄ consisting of 45 to 65 mol % LiAlCl₄ and 35 to 55 mol % NaAlCl₄.

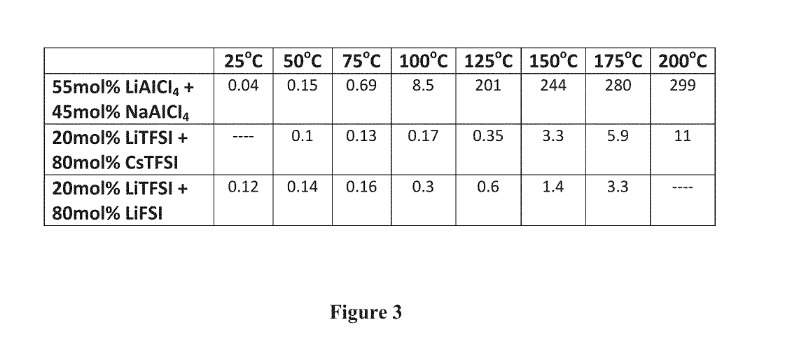

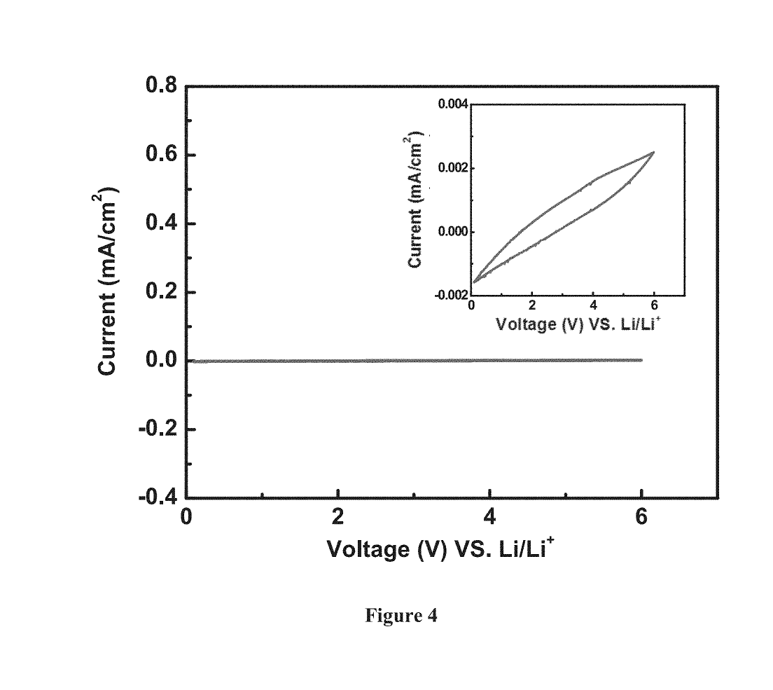

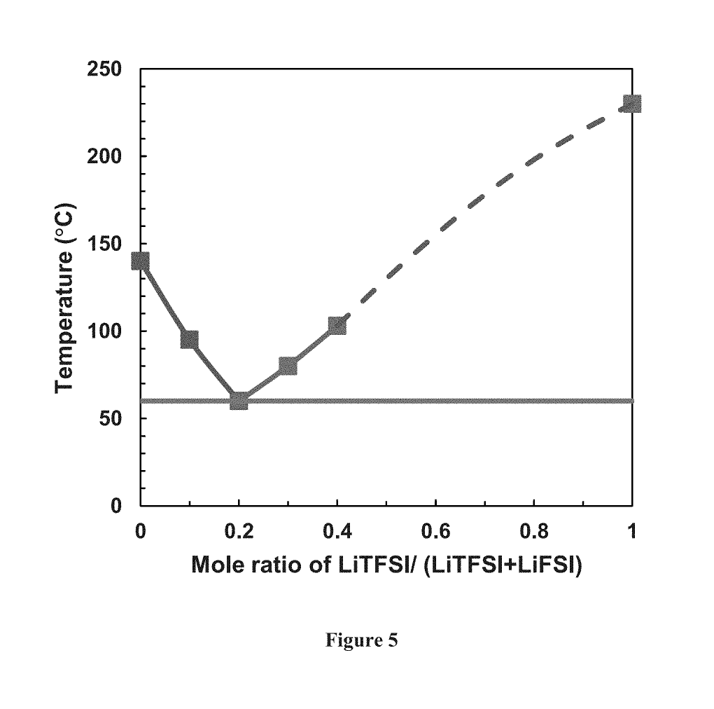

The ionic conductivities—conductivity unit: mS/cm—of a few of these lithium salt mixtures at different temperatures are shown in the table of FIG. 3. From FIG. 3, it can be seen that these selected salt mixtures exhibit good ionic conductivity of around 0.1 mS/cm below 50° C., which is comparable to other state-of-the-art solid-state Li-ion conductors such as LISICON, Li₇La₃Zr₂O₁₂. The electrochemical stability of the salt mixture of LiTFSI and LiFSI is up to 6 V, as shown in the cyclic voltammogram curve of the salt mixture of 20 mol % LiTFSI and 80 mol % LiFSI in FIG. 4. Meanwhile, all of these salt mixtures show excellent chemical compatibility with the aforementioned cathode and anode materials, which is pertinent to retaining the performance of both the solid electrolytes and electrodes. Another advantage of these salt mixtures is that they have much lower melting points (below 150° C.) compared to the above-mentioned traditional solid-state Li-ion conductors. For example, with a eutectic composition of 45 mol % NaAlCl₄, the salt mixture of LiAlCl₄ and NaAlCl₄ is in a molten state above 103° C. The melting point of salt mixture of LiTFSI and LiFSI is as low as 60° C., as shown in the phase diagram of the LiFSI and LiTFSI binary system of FIG. 5. During battery cathode fabrication process in a temperature range between approximately 100 and 150° C., the mixed salt electrolyte is in the molten state, which therefore can ensure excellent contact between the electrolyte and electrode particles. Meanwhile, such a low temperature battery fabrication process eliminates the above-mentioned issues associated with traditional high-temperature treatment processes, such as side reactions between cell components and thermal instability of battery materials.

The materials for solid-state electrolytes of the present invention are non-flammable, non-toxic, inexpensive, and easy to synthesize, which ensures that this type of solid-state Li-ion batteries is both safe and low cost. The electrolyte also can be a combination of the above-mentioned lithium-containing salts and other solid-state Li-ion conductors such as LISICON, Li₇La₃Zr₂O₁₂. In such a case, the low melting point salt or salt mixture can serve as the bonding agent between the solid-state Li-ion conductors and electrode materials, which should ensure an excellent Li-ion conducting pathway in the battery.

The electrode materials can be any of the conventional Li-ion battery electrode materials, such as LiFePO₄, LiCoO₂, or other lithium containing metal oxides for the cathode 130 and graphite, Li₄Ti₅O₁₂, or other anode materials for the anode 100.

In one embodiment, the anode active material is lithium, graphite, Si, SiOₓ (0<x≦2), Sn, SnO₂, Ge, Co₂O₃, Fe₂O₃, TiO₂, or Li₄Ti₅O₁₂.

The cathode active material may be, but is not limited to, a lithium intercalation compound or a lithium containing compound. The cathode active material may be, but is not limited to, Li₄₋ₓMₓTi₅O₁₂ (M=Mg, Al, Ba, Sr, or Ta; 0≦x≦1), MnO₂, Li₃V₂O₅, LiV₃O₈, LiM^{C1}ₓM^{C2}₁₋ₓO₂ ((M^{C1} or M^{C2}=Fe, Mn, Ni, Co, Cr, Ti, Mg, Al; 0≦x≦1), LiM^{C1}ₓM^{C2}_{y}M^{C3}_{1-x-y}O₂ ((M^{C1}, M^{C2}, or M^{C3}=Fe, Mn, Ni, Co, Cr, Ti, Mg, or Al; 0≦x≦1; 0≦y≦1), LiMn_{2-y}X_{y}O₄ (X=Cr, Al, or Fe, 0≦y≦1), LiNi_{0.5-y}X_{y}Mn_{1.5}O₄ (X=Fe, Cr, Zn, Al, Mg, Ga, V, or Cu; 0≦y<0.5), xLi₂MnO₃.(1-x)LiM^{C1}_{y}M^{C2}_{z}M^{C3}_{1-y-z}O₂ (M^{C1}, M^{C2}, or M^{C3}=Mn, Ni, Co, Cr, Fe, or mixture of; x=0.3-0.5; y≦0.5; z≦0.5), Li₂MSiO₄ (M=Mn, Fe, or Co), Li₂MSO₄ (M=Mn, Fe, or Co), LiMSO₄F (Fe, Mn, or Co), LiM^{C1}ₓM^{C2}₁₋ₓPO₄ (M^{C1} or M^{C2}=Fe, Mn, Ni, Co, Cr, or Ti; 0≦x≦1), Li₃V₂₋ₓMₓ(PO₄)₃ (M=Cr, Co, Fe, Mg, Y, Ti, Nb, or Ce; 0≦x≦1), LiVPO₄F, Li₂₋ₓ(Fe_{1-y}Mn_{y})P₂O₇ (0≦y≦1).

In one embodiment, the fabrication process for the battery 100 is carried out at temperatures between 100 and 300° C. and, in one embodiment, below 200° C. During the process, powders of electrode active materials and conductive carbon can be well mixed with the molten state electrolyte to ensure intimate contact among the three components—the electrolyte, active materials, and conductive carbon. Then the molten slurry can be coated onto a selected current collector at same temperatures. Under such a treatment, the properties and structures of electrode active materials will not be deteriorated. Meanwhile, this approach will dramatically reduce the high interfacial resistance encountered in conventional solid state batteries such as poor contacts among particles of solid-state electrolyte, electrode active materials and conductive carbon.

In one embodiment, during the fabrication, multiple layers consisting of solid state anode, electrolyte and cathode can be hot-laminated in with the above-mentioned process, which will significantly reduce the cost of battery fabrication. The battery operation temperature can be below 80° C., and even below 50° C. in other embodiments, with all of the battery components in solid state.

During electrode fabrication at temperatures between 100 and 300° C., the powders of electrode active materials, such as LiFePO₄ or LiCoO₂ cathode and graphite or Li₄Ti₅O₁₂ anode, and conductive carbon can be well mixed with a molten state electrolyte to ensure intimate contact among the three components (electrolyte, active material and conductive carbon). At temperatures above 100° C., the molten salt electrolyte in a composite inorganic solid electrolyte becomes molten which simplifies the electrode fabrication process and avoids high-temperature treatment.

The molten slurry can be coated onto appropriate current collectors at elevated temperatures. In this intermediate temperature range, the properties, structure, and performance of the electrode—both cathode and anode—active materials will not be affected. After cooling to below 100° C., the electrode assembly will be in a solid state, in some cases preserving a plastic solid behavior. This fabrication approach will dramatically reduce the high interfacial resistance encountered in conventional solid-state batteries, which is due to inevitable surface irregularities of the electrolyte and electrode materials limiting contact area between the two. As a consequence, the internal resistance in the new cell design will be significantly lower than in conventional solid-state Li-ion batteries. During the single cell fabrication, multiple layers consisting of solid-state anode, electrolyte, and cathode can be hot-laminated in one single step. By enabling the use of well-established, low-cost die extrusion coating processes optimized over decades in the plastic film industries, manufacturing costs can be significantly reduced.

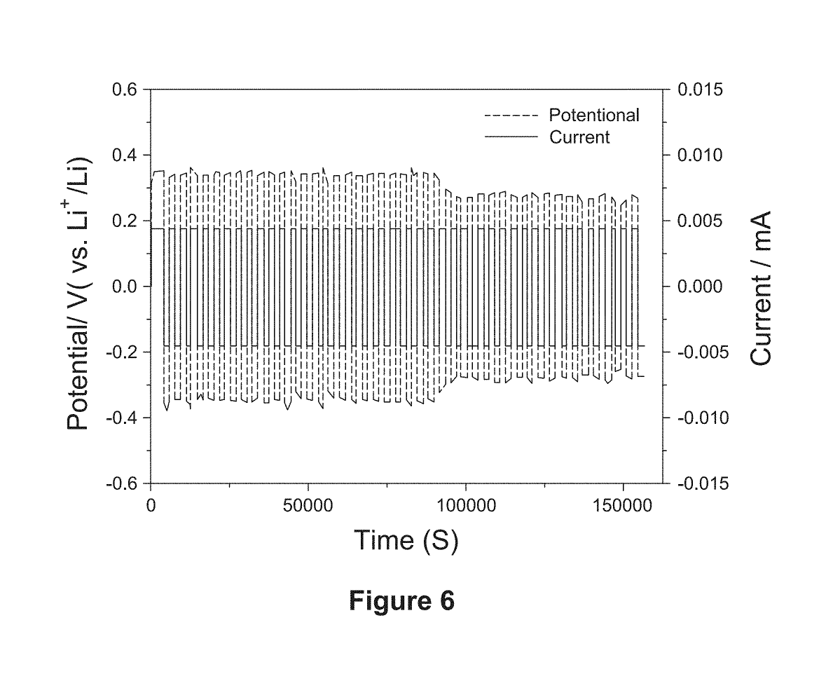

FIG. 6 shows stability of an electrolyte mixture which is approximately 20 mol % LiTFSI and approximately 80 mol % LiFSI in a coin cell type configuration shown in FIG. 2. Li is used as both cathode and anode. The separator was a 20 μm thick glass fiber membrane. For cell assembling, a separator is laid on the top of a piece of Li metal electrode. The electrolyte mixture was heated to 90° C. until it became flow state and then soaked in the separator. Another piece of Li metal is attached on top of the separator. The cell was then cooled down to room temperature before electrochemical test. The process of Li deposition-dissolution was conducted at 5 μA at an interval of 30 min. The voltage was stable for more than 400 cycles.

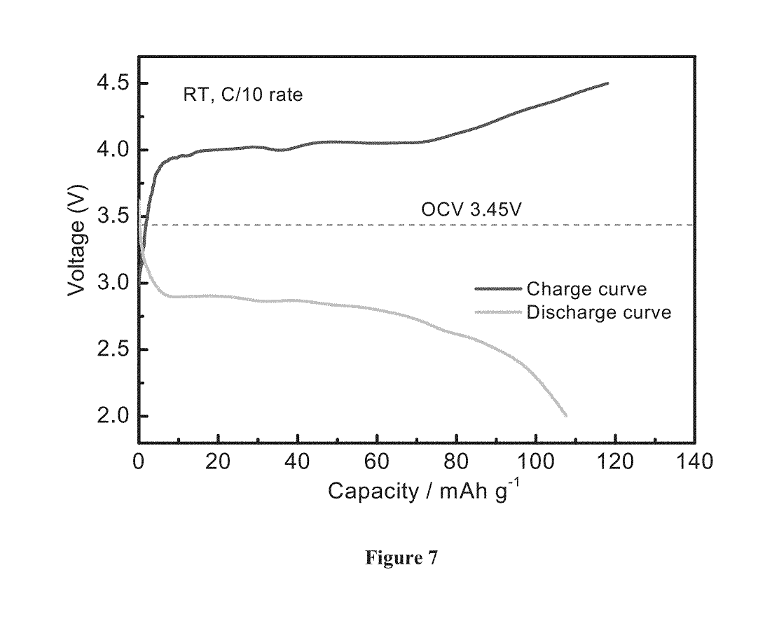

FIG. 7 shows charge/discharge characteristics of the solid-state Li-ion battery with a low-melting point lithium salt mixture electrolyte. The battery has a coin cell type configuration shown in FIG. 2. LiFePO₄ is used as cathode and Li metal is used as anode. The LiFePO₄ electrode was prepared by mixing 80 wt % LiFePO₄, 10 wt % super P carbon black and 10 wt % PVDF binder in N-methyl-2-pyrrolidone (NMP) solution to form a slurry, and then cast the slurry onto an Al current collector. The electrode was dried at 80° C. under vacuum for 6 h. 2032 type coin cells were assembled with above LiFePO₄ film as working electrode, lithium foil as counter electrode and glass fiber film (20 μm) as separator. The electrolyte is a mixture of approximately 20 mol % LiTFSI and approximately 80 mol % LiFSI. For cell assembling, the electrolyte mixture was heated to 90° C. until it became flow state and then dipped onto the electrodes. A piece of separator is then attached to the top of the cathode and also soaked with molten electrolyte. A piece of Li metal is attached on top of the separator. The cell was then cooled down to room temperature before electrochemical test. The cell was charged and discharged at 0.1 C rate between 2.0 V and 4.5 V.

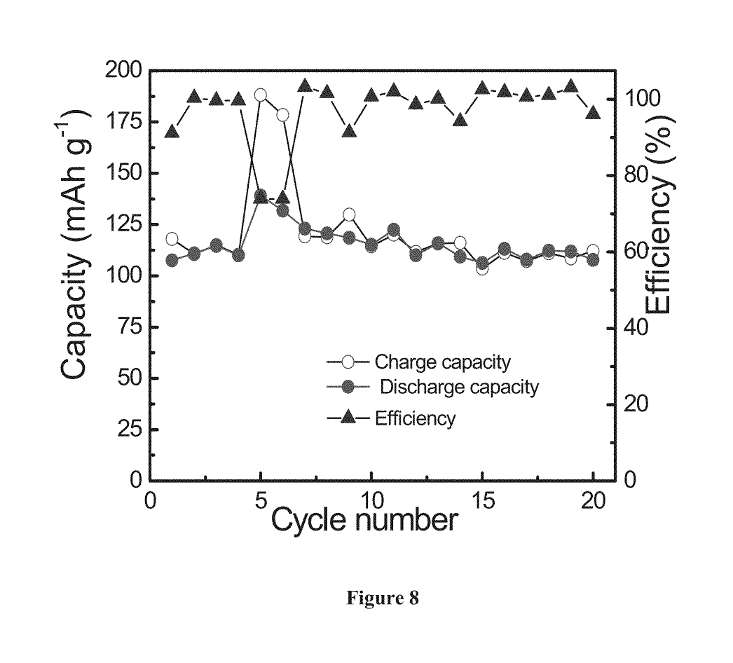

Performance of the battery with the low-melting point lithium salt mixture electrolyte was tested at approximately 25 degrees Celsius The current rate was approximately 0.1 C, with a reversible capacity of approximately 110 mAh g⁻¹ and an average discharge voltage of approximately 2.83 volts. FIG. 8 shows the capacity and efficiency of this battery as a function of cycle numbers.

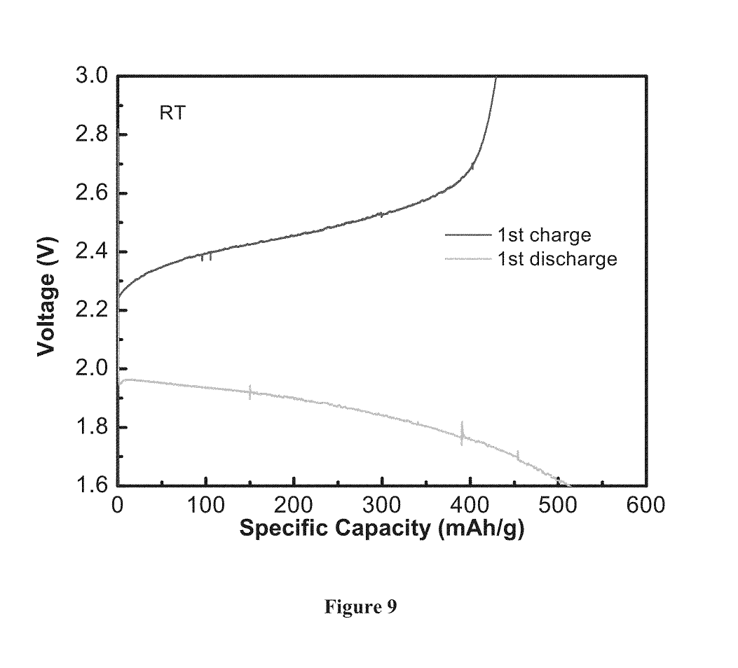

FIG. 9 shows the voltage profile of a solid-state Li—S battery with a low-melting point lithium salt mixture electrolyte during the first charge/discharge cycle. The battery has a coin cell type configurations shown in FIG. 2 with Li as anode and sulfur/carbon mixture as cathode. Sulfur/carbon composite was prepared by heat treating 80 wt % sulfur powder, 20 wt % Ketjenblack mixture at 155° C. for 12h in Teflon-lined stainless steel autoclave, to improve the sulfur distribution inside the carbon framework. The sulfur electrode film was prepared by mixing 80 wt % the above S/C composite material, 10 wt % Super P carbon black, and 10 wt % PVDF binder in NMP solution to form a slurry. The slurry was then casted onto an aluminum current collector. The electrode was dried at 80° C. under vacuum for 6 h. 2032 type coin cells were assembled with above sulfur composite film as cathode, lithium foil as anode, and glass fiber film (20 μm) as separator. The electrolyte is a mixture of approximately 20 mol % LiTFSI and approximately 80 mol % LiFSI. For cell assembling, the electrolyte mixture was heated to 90° C. until they became flow state and then dipped onto the S/C cathodes. A piece of separator is then attached to the top of the cathode and also soaked with molten electrolyte. A piece of Li metal is attached on top of the separator. The cell was cooled down to room temperature before electrochemical test. The cell was charged and discharged at 0.05 C rate between 1.6 V and 3.0V.

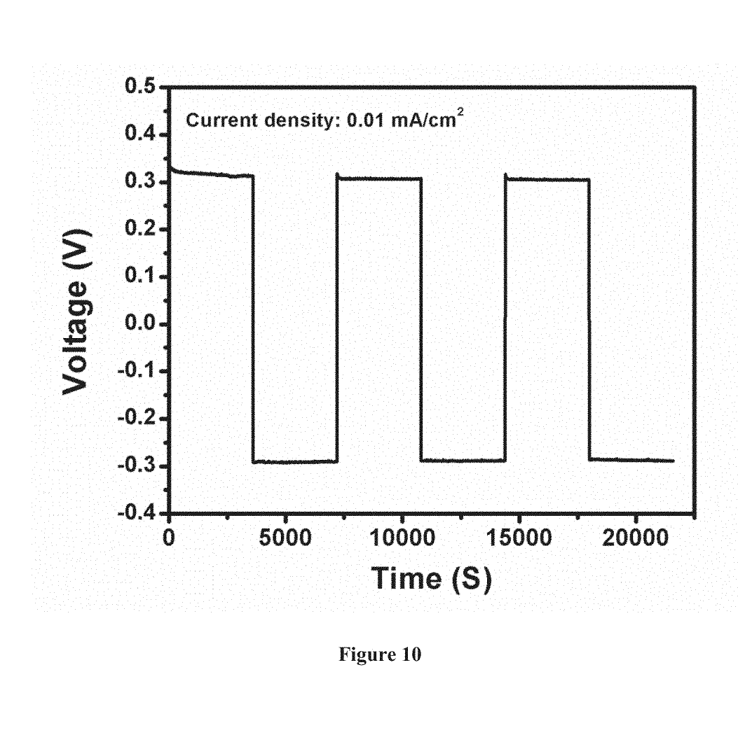

FIG. 10 shows the voltage curves of the first three charge/discharge cycles of a solid-state Li|Li symmetric battery with LiTFSI as the electrolyte in a pellet form at a current density of 0.01 mA/cm². The battery has a coin cell type configuration shown in FIG. 2 with Li as both positive and negative electrode. The thickness of the pellet was approximately 1 mm. The solid electrolyte was stable with lithium metal. The overall potential was around 0.3 volts.

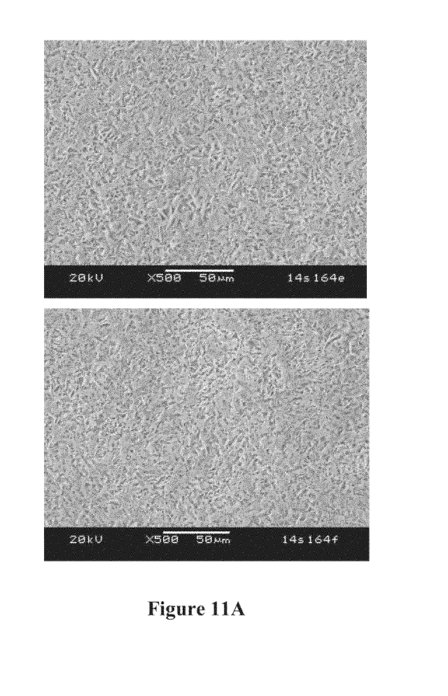

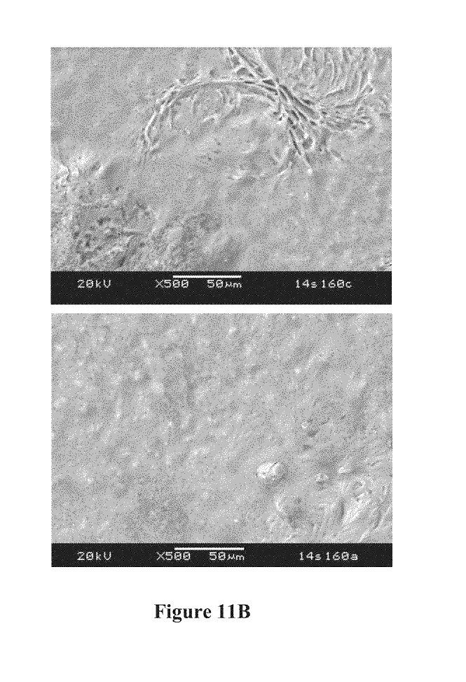

FIG. 11A shows the morphology of pristine LiTFSI pellets. FIG. 11B shows the morphology of melted LiTFSI pellets at approximately 280 degrees Celsius. After melting the LiTFSI pellets at approximately 280 degrees Celsius, the pellet thickness was reduced from approximately 1 mm to approximately 0.5 mm. As shown FIG. 11B, the surface pores disappeared.

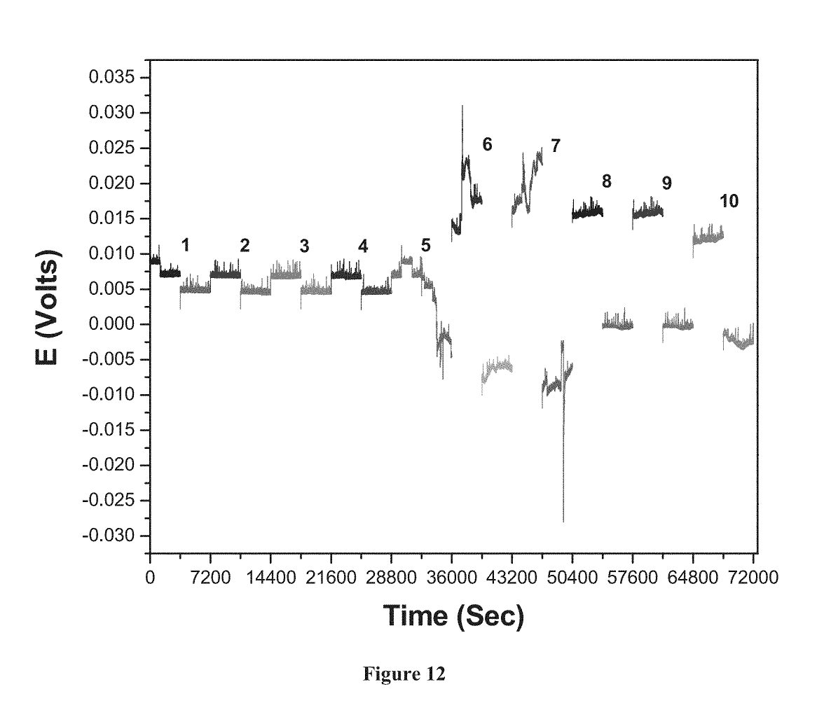

FIG. 12 shows the effects of 10 cycles of a solid-state Li|Li symmetric battery with LiTFSI mixed with Al₂O₃(1:1 wt.) as the electrolyte at a current density of 0.01 mA/cm². Pellet thickness was approximately 0.5 mm. The voltage scan range was from −2 to 2 volts, and data was collected at 1 points/sec. Some noise was found which could be caused by moisture and/or other external contaminants.

### Example of LiTFSI Solid-State Electrolyte

The following examples serve to illustrate one embodiment for a LiTFSI pellet making procedure, including cell assembly and testing.

### LiTFSI Pellet Making Procedure

130 mg LiTFSI fine powder were loaded into a pressing die in an Ar glovebox. The die was transferred onto a die presser and applied with 7500 lb. pressure for 3 min to make the solid palette. Then the die was placed into a preheated oven (270° C.) for 30 min. After heating, the die was loaded back to the glovebox for cooling about 3 hr. The resulting palette was easily peeled off from the die. The thickness of the palette is ca. 0.65 mm.

### Cell Assembling and Testing

Li metal palettes were pretreated in a 1.0 M LiTFSI PC solution overnight. Take one piece of the Li palette and place it onto a piece of steel current collector. Then add the LiTFSI palette on the top of the Li metal, and then place the second Li metal and the second current collector. The assembly was carefully pressed using tweezers. Then the cell was placed onto a testing framework for chronopotentiometry and CV tests.

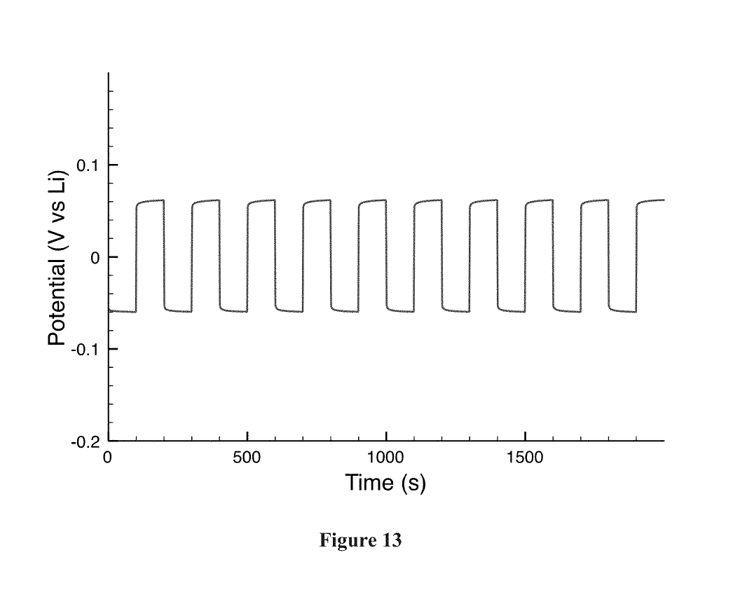

FIG. 13 shows a representative chronopotentiometry of a LiTFSI solid-state electrolyte using a half cell configuration in which the solid-state electrolyte was sandwiched between two stainless steel current collectors loaded with Li metal discs. The cycling time for 10 cycles was 200 seconds for each cycle, and the cycling profile shows ca. 0.06 V overpotential.

The disclosed Li-ion batteries, methods of manufacturing, and electrolyte compositions will enable compelling improvements to state-of-the-art solid state Li-ion batteries. The embodiments disclosed herein will dramatically reduce the high interfacial resistance encountered in conventional solid-state batteries in which only point-to-point contacts instead of full surface contacts exist among particles of solid-state electrolytes, electrode active materials, and conductive carbon. Because of the absence of flammable electrolytes, the disclosed Li-ion batteries are robust against crash, fire, and other safety hazards and are suitable for the next generation electric vehicle applications. The embodiments disclosed herein also lead to reduced costs from the use of low-cost precursors—which are compatible with high-volume manufacturing.

The solid state electrolytes of the present invention also have potential to be used in microbatteries by using 3D printing. Due to the compact structure and small volume of microbatteries, the electrolytes may be incorporated into products such as microbatteries for microtransmitters and sensors.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

We claim:

1. A method of manufacturing a solid-state lithium-ion battery comprising:
a. preparing a molten-state electrolyte layer slurry and casting it on a non-metallic porous membrane;
b. preparing a cathode layer slurry containing the electrolyte, a cathode active material and carbon, and casting the cathode slurry on an aluminum substrate;
c. preparing an anode layer slurry containing the electrolyte, an anode active material and carbon, and casting the anode slurry on a copper substrate;
d. stacking together the cathode layer, the electrolyte layer and the anode layer; and
e. laminating or hot pressing the stacked layers;
wherein the battery manufacturing is carried out at temperatures below 300 degrees Celsius.

2. The method of claim 1 wherein the battery is manufactured at temperatures below 150 degrees Celsius.

3. The method of claim 1 wherein the electrolyte for the electrolyte slurry layer contains a salt or salt mixture selected from one of the following: LiFSI, LiTFSI, LiTFSI and LiFSI, CsTFSI, LiTFSI and CsTFSI, LiAlCl₄ and NaAlCl₄, LiFeCl₄, NaFeCl₄, CsI, LiI, CsNO₃, LiNO₃, KNO₃, NaNO₃, AlF₃, or combinations thereof.

4. The method of claim 3 wherein the electrolyte further includes at least one of the following: LISICON, Li₇La₃Zr₂O₁₂, doped Li₇La₃Zr₂O₁₂, Li-beta-alumina, Li₃ₓLa_{2/3-x}TiO₃ (LLTO) (x=0.05 to 0.3), or combinations thereof.

5. The method of claim 4 wherein the electrolyte is a mixture of LiTFSI and LiFSI.

6. The method of claim 5 wherein the electrolyte mixture is 10 to 30 mol % LiTFSI and 70 to 90 mol % LiFSI.

7. A method of manufacturing a solid-state lithium-ion battery comprising:
a. dissolving a solid-state electrolyte into a first organic solvent with a boiling point less than 210 degrees Celsius to form an electrolyte solution;
b. casting the electrolyte solution on a non-metallic porous membrane and the first organic solvent is evaporated and a solid state electrolyte layer is formed;
c. dispersing cathode active material and carbon into an electrolyte solution prepared in claim 18a to form a cathode slurry, wherein the cathode slurry is cast on an aluminum substrate and the organic solvent is evaporated;
d. dispersing anode active material and carbon into an electrolyte solution prepared in 18a to form anode slurry, wherein the anode slurry is cast on an copper substrate and the organic solvent is evaporated; and
e. stacking together the cathode layer, the electrolyte layer, and the anode layer by laminating or pressing, wherein the battery manufacturing is carried out at temperatures below 300 degrees Celsius.

8. The method of claim 7 wherein organic solvent is dimethyl carbonate.

9. A method of manufacturing a solid-state lithium-ion battery comprising:
a. dissolving a solid-state electrolyte into an organic solvent with a boiling point less than 210 degrees Celsius to form an electrolyte solution;
b. dispersing cathode active material and carbon into an electrolyte solution containing dissolved solid state electrolyte and an organic solvent with a boiling point less than 210 degrees Celsius to form a cathode slurry, wherein the cathode slurry is cast on an aluminum substrate and the organic solvent is evaporated to form a solid state cathode;
c. casting the electrolyte solution prepared in claim 20a on the surface of the cathode layer and the organic solvent is evaporated to form a solid state electrolyte layer;
d. dispersing/mixing anode active material and carbon into an electrolyte solution containing dissolved solid state electrolyte and an organic solvent with a boiling point less than 210 degrees Celsius to form a anode slurry, wherein the anode slurry is cast on the surface of the solid state electrolyte layer prepared in claim 20c. The organic solvent is evaporated to form a solid state anode layer; and
e. adding a copper foil on the top of anode layer as the anode current collector and laminating the stack together, wherein the battery manufacturing is carried out at temperatures below 300 degrees Celsius.

10. The method of claim 9 wherein organic solvent is dimethyl carbonate.

11. A method of manufacturing a solid-state lithium-ion battery comprising:
a. preparing a molten-state electrolyte layer slurry, a cathode slurry containing the electrolyte, a cathode active material and carbon, and an anode slurry containing the electrolyte, an anode active material and carbon;
b. stacking the layers together on a substrate; and
c. rolling the stacked layers,
wherein the battery manufacturing is carried out at temperatures below 300 degrees Celsius.

12. The method of claim 11 wherein the battery is manufactured at temperatures below 150 degrees Celsius.

13. The method of claim 11 wherein the electrolyte for the electrolyte slurry layer contains a salt or salt mixture selected from one or more of the following: LiTFSI, LiFSI, LiTFSI and LiFSI, CsTFSI, LiTFSI and CsTFSI, LiAlCl₄ and NaAlCl₄, LiFeCl₄, NaFeCl₄, CsI, LiI, CsNO₃, LiNO₃, KNO₃, NaNO₃, AlF₃, or combinations thereof.

14. The method of claim 13 wherein the electrolyte further includes at least one of the following: LISICON, Li₇La₃Zr₂O₁₂, doped Li₇La₃Zr₂O₁₂, Li-beta-alumina, Li₃ₓLa_{2/3-x}TiO₃ (LLTO) (x=0.05 to 0.3), or combinations thereof.

15. The method of claim 13 wherein the electrolyte is a mixture of LiTFSI and LiFSI.

16. The method of claim 15 wherein the electrolyte mixture is 10 to 30 mol % LiTFSI and 70 to 90 mol % LiFSI.

17. An electrolyte mixture for a solid-state lithium-ion battery comprising LiTFSI and LiFSI.

18. The electrolyte mixture of claim 17 wherein the electrolyte mixture is 10 to 30 mol % LiTFSI and 70 to 90 mol % LiFSI.

19. The electrolyte mixture of claim 17 wherein the electrolyte mixture is approximately 20 mol % LiTFSI and approximately 80 mol % LiFSI.

20. An electrolyte mixture for a solid-state lithium-ion battery comprising 0 to 100 mol % LiTFSI.

21. The electrolyte mixture of claim 20 wherein the electrolyte mixture includes at least one of the following: Li-beta-alumina and Li₇La₃Zr₂O₁₂.
